(19) United States
(12) Patent Application Publication
(10) Pub. No.: US 2019/0028409 A1
(43) Pub. Date: Jan. 24, 2019

(54) VIRTUAL SWITCH DEVICE AND METHOD

(71) Applicant: ALIBABA GROUP HOLDING LIMITED, George Town (KY)

(72) Inventor: Xiaowei JIANG, San Mateo, CA (US)

(21) Appl. No.: 15/654,631

(22) Filed: Jul. 19, 2017

(51) Int. Cl. H04L 12/931; H04L 12/741; H04L 12/721

(52) U.S. Cl. CPC H04L 49/70; H04L 45/74; H04L 45/7453; H04L 45/38; H04L 49/354

(57) ABSTRACT

Embodiments of the disclosure provide a virtual switch device and method for distributing packets. A peripheral card can include a peripheral interface configured to communicate with a host system having a controller, receiving one or more packets from the host system; a processor unit configured to process the packets according to configuration information provided by the controller; a packet processing engine configured to route the packets according to a flow table established via the processor unit; and a network interface configured to distribute the routed packets.

### TECHNICAL FIELD

The present disclosure relates to the field of computer architecture, and more particularly to a virtual switch device and method for distributing packets.

### BACKGROUND

In cloud computing service, a virtual switch (Vswitch) is a software layer that mimics a physical network switch that routes packets among nodes. Conventionally, the Vswitch is deployed in a host system that runs the cloud computing service.

Running software codes for the Vswitch on the central processing units (CPUs) of the host system is inherently inefficient. Furthermore, the Vswitch oftentimes requires CPUs to be dedicated to it in order to achieve its optimal performance. However, in the Infrastructure as a Service (IaaS) cloud (e.g., Aliyun provided by Alibaba), CPUs are valuable resources that are priced as commodities to cloud customers. Thus, CPUs dedicated to the Vswitch should be excluded from the resource pool that can be sold to cloud customers. Accordingly, minimizing the load on the CPUs of the host system along with providing optimal performance for switching is preferable.

### SUMMARY

Embodiments of the disclosure provide a peripheral card for distributing packets, the peripheral card comprising: a peripheral interface configured to communicate with a host system having a controller, receiving one or more packets from the host system; a processor unit configured to process the packets according to configuration information provided by the controller; a packet processing engine configured to route the packets according to a flow table established via the processor unit; and a network interface configured to distribute the routed packets.

Embodiments of the disclosure further provide a method for distributing packets, the method comprising: receiving, via a virtual switch, one or more packets from a host system having a controller; processing, via the virtual switch, the packets according to configuration information provided by the controller; routing, via the virtual switch, the packets according to a flow table; and distributing, via the virtual switch, the routed packets.

Embodiments of the disclosure further provide a communication system comprising a host system and a peripheral card, wherein the host system comprises a controller; the peripheral card comprises: a peripheral interface configured to communicate with a host system having a controller, receiving one or more packets from the host system; a processor unit configured to process the packets according to configuration information provided by the controller; a packet processing engine configured to route the packets according to a flow table established via the processor unit; and a network interface configured to distribute the routed packet.

Embodiments of the disclosure further provide a non-transitory computer readable medium that stores a set of instructions that is executable by at least one processor of a device to cause the device to perform a method for distributing packets, the method comprising: receiving one or more packets from a host system having a controller; processing the packets according to configuration information provided by the controller; routing the packets according to a flow table; and distributing the routed packets.

Additional objects and advantages of the disclosed embodiments will be set forth in part in the following description, and in part will be apparent from the description, or can be learned by practice of the embodiments. The objects and advantages of the disclosed embodiments can be realized and attained by the elements and combinations set forth in the claims.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a structural diagram of a virtual switch for routing packets.

FIG. 2 illustrates a structural diagram of an exemplary peripheral card, consistent with embodiments of the present disclosure.

FIG. 3 illustrates a block diagram of an exemplary host system, consistent with embodiments of the present disclosure.

FIG. 4 illustrates an exemplary initialization procedure of communication between a processor unit and a controller, consistent with embodiments of the present disclosure.

FIG. 5 illustrates an exemplary data flow for peripheral card to process packets, consistent with embodiments of the present disclosure.

FIG. 6 is a flow chart of an exemplary method for distributing packets, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

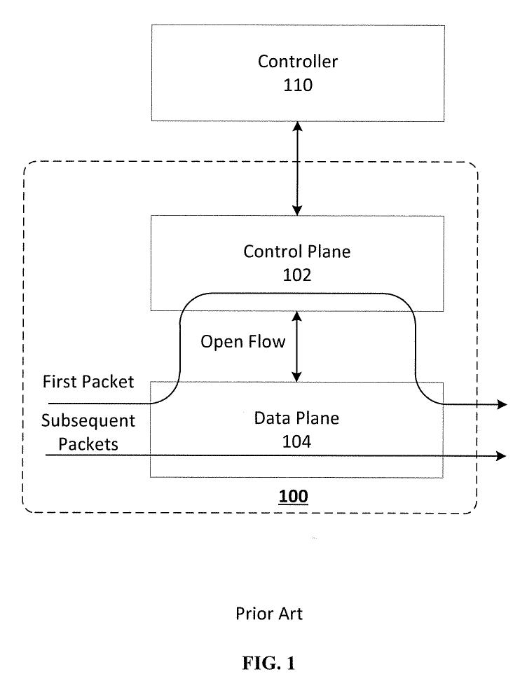

FIG. 1 illustrates a structural diagram of a virtual switch 100 for routing packets.

Virtual switch 100 can include a control plane 102 and a data plane 104. Control plane 102 can determine where the packets should be sent, so as to generate and update a flow table. The flow table includes routing information for packets, and can be passed down to data plane 104. Therefore, data plane 104 can forward the packets to a next hop along the path determined according to the flow table.

For example, when an ingress packet is sent to virtual switch 100, the ingress packet can be processed by data plane first. If there is a matching route for the ingress packet in the flow table, the ingress packet can be directly forwarded to the next hop according to the matching route. The above process can be performed in a very short time, and therefore, data plane 104 can also be referred to as a fast path. If no matching route can be found in the flow table, the ingress packet can be considered as a first packet for a new route and sent to control plane 102 for further processing. That is, control plane 102 can be only invoked when the ingress packet misses in data plane 104. As described above, control plane 102 can then determine where the first packet should be sent and update the flow table accordingly. Therefore, the subsequent packets in this flow route can be handled by data plane 104 directly. The above process of control plane 102 takes a longer time than data plane 104, and thus control plane 102 can be also referred to as a slow path.

Conventionally, both control plane 102 and data plane 104 of the virtual switch 100 are deployed in a host system. The host system can further include a user space and a kernel space. The user space runs processes having limited accesses to resources provided by the host system. For example, processes (e.g., virtual machines) can be established in the user space, providing computation to the customers of the cloud service. The user space can further include a controller 110, having a role as an administration of control plane 102. In one embodiment of conventional systems, control plane 102 can also be deployed in the user space of the host system, while data plane 104 can be deployed in the kernel space. In another embodiment of conventional systems, control plane 102 can be deployed in the kernel space of the host system, along with data plane 104. The kernel space can run codes in a “kernel mode”. These codes can also be referred to as the “kernel.” The kernel is the core of the operating system of the host system, with control over basically everything in the host system. No matter if control plane 102 is deployed in the user space or the kernel space, running virtual switch 100 including control plane 102 and data plane 104 is a burden to the host system.

Embodiments of the disclosure provide a virtual switch device and method for distributing packets to offload the functionality of switching from the host system. The virtual switch device can be communicatively coupled with a host system capable of running a plurality of virtual machines that transmit and receive packets to be distributed. The virtual switch device can include a packet processing engine and a processor unit for respectively performing functions of a fast path and a slow path of a conventional virtual switch. Therefore, the host system is merely responsible for initializing the virtual switch device, thus minimizing the load on the CPUs of the host system along with providing optimal performance for switching.

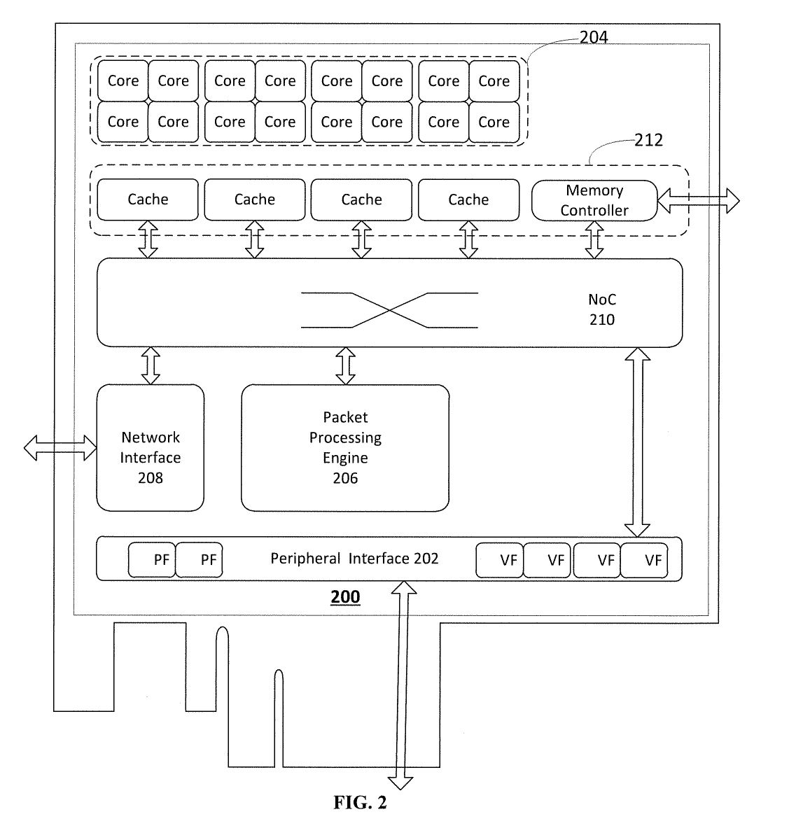

FIG. 2 illustrates a structural diagram of an exemplary peripheral card 200, consistent with embodiments of the present disclosure.

Peripheral card 200 can include a peripheral interface 202, a processor unit 204, a packet processing engine 206, and a network interface 208. The above components can be independent hardware devices or integrated into a chip. In some embodiments, peripheral interface 202, processor unit 204, packet processing engine 206, and network interface 208 are integrated as a System-on-Chip, which can be further deployed to peripheral card 200.

Peripheral interface 202 can be configured to communicate with a host system having a controller and a kernel (not shown), receiving one or more packets from the host system or an external source. That is, peripheral card 200 of the present disclosure can process not only packets from/to the host system, but also packets from/to the external source. In some embodiments, peripheral interface 202 can be based on a parallel interface (e.g., Peripheral Component Interconnect (PCI)), a serial interface (e.g., Peripheral Component Interconnect Express (PCIe)), etc. As an illustrative example, peripheral interface 202 can be a PCI Express (PCIE) core, providing connection with the host system in accordance to the PCIE specification. The PCIE specification can further provide support for the “single root I/O virtualization” (SR-IOV). SR-IOV allows a device (e.g., peripheral card 200) to separate access to its resources among various functions. The functions can include a physical function (PF) and a virtual function (VF). Each VF is associated with the PF. A VF shares one or more physical resources of peripheral card 200, such as a memory and a network port, with the PF and other VFs on peripheral card 200. The virtual switch functionality of peripheral card 200 can be directly accessed by the virtual machines through the VF. Thus, in some embodiments, peripheral card 200 is a PCIE card plugged in the host system.

Processor unit 204 can be configured to process the packets according to configuration information provided by the controller of the host system. The configuration information can include configurations for initializing processor unit 204. The configurations can include, for example, Forwarding Information Database (FIB), Address Resolution Protocol (ARP) table, Access Control List (ACL) rules. In some embodiments, processor unit 204 can include a plurality of processor cores. For example, the processor cores can be implemented based on the ARM™ Cortex™-A72 core. With the computation provided by the plurality of processor cores, processor unit 204 can run a full-blown operating system including the functionality of a control plane (a slow path). The slow path functionality can be performed by running slow path codes deployed on the operating system. When processor unit 204 is initialized by the configuration information, a flow table including flow entries can be established by processor unit 204 for routing the packets. And processor unit 204 can be further configured to update the flow table with a new flow entry corresponding to a first packet of a new route, if the first packet fails to find a matching flow entry in the data plane.

Packet processing engine 206 is the hardware implementation of a data plane (or a fast path), and can be configured to route the packets according to the flow table established via processor unit 204. After processor unit 204 establishes the flow table, the flow table can be written or updated into packet processing engine 206 accordingly.

When an ingress packet is received, packet processing engine 206 can determine whether the ingress packet has a matching flow entry in the flow table. After packet processing engine 206 determines that the ingress packet has a matching flow entry, packet processing engine 206 generates a route for the ingress packet according to the matching flow entry. After packet processing engine 206 determines that the packet has no matching flow entry, packet processing engine 206 generates an interrupt to processor unit 204.

Processor unit 204 can then receive the interrupt generated by packet processing engine 206, process the ingress packet by the slow path codes of the operating system to determine a flow entry corresponding to the ingress packet, and update the flow entry into the flow table. Packet processing engine 206 can then determine a route for the ingress packet according to updated flow table. Subsequent packets corresponding to the determined flow entry can then be routed by packet processing engine 206 directly.

Network interface 208 can be configured to distribute the routed packets. In some embodiments, network interface 208 can be a network interface card (NIC) that implements L0 and L1 of networking stacks. Network interface 208 can be further configured to receive one or more packets from an external source (or, an external node), and forward the received packet to other components (e.g., processor unit 204 or packet processing engine 206) for further processing. That is, processor unit 204 or packet processing engine 206 can, for example, process packets from virtual machines of the host system and/or an external source.

As shown in FIG. 2, peripheral card 200 can further include other components, such as a network-on-chip (NoC) 210, a memory device 212, or the like.

NoC 210 provides a high-speed on-chip interconnection for all major components of peripheral card 200. For example, data, messages, interrupts, or the like can be communicated among the components of peripheral card 200 via NoC 210. It is contemplated that NoC 210 can be replaced by other kinds of internal buses.

Memory device 212 can be implemented as any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk. In some embodiments, memory device 212 can include a plurality of cache devices controlled by a memory controller. The cache devices can be configured to store one or more instructions, the configuration information, the flow table, or the like. In some embodiments, memory device 212 can perform a two-level caching. For example, memory device 212 can cache data (e.g., the flow table, the VPORT able, the ARP table, or the like) using a telecommunication access method (TCAM) or SRAM on peripheral card 200 for fast access. Memory device 212 further cache a larger fraction of the data in a double data rate (DDR) memory device on peripheral card 200.

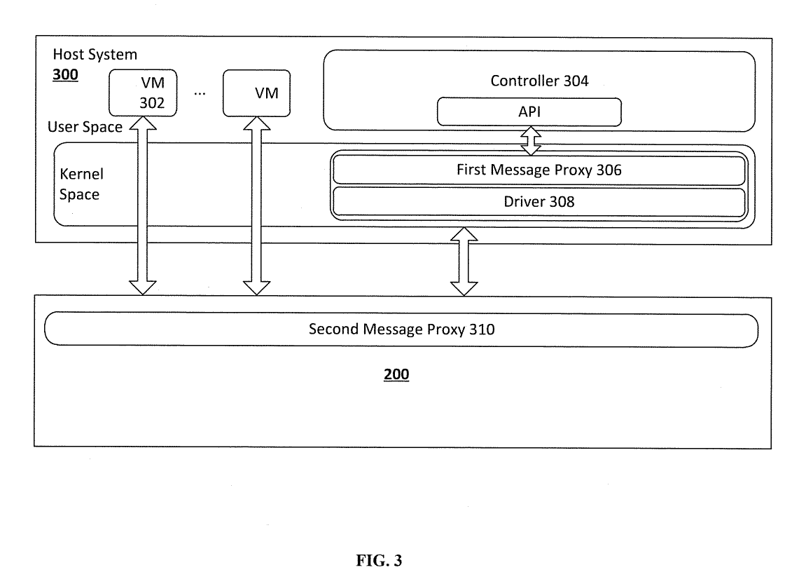

As discussed above, peripheral card 200 can be connected to a host system. FIG. 3 illustrates a block diagram of an exemplary host system 300, consistent with embodiments of the present disclosure.

As shown in FIG. 3, host system 300 can include at least one virtual machine (VM) 302 and a controller 304 in the user space, and a first message proxy 306 and a driver 308 in the kernel space. On the side of peripheral card 200, a second message proxy 310 can be generated by the operating system run by processor unit 204 of peripheral card 200.

Each VM 302 can provide cloud services to an individual customer, and therefore generate packets to be routed by the virtual switch functionality of peripheral card 200. As discussed above, the communication between at least one VM 302 and peripheral card 200 can be implemented by PFs and VFs of peripheral interface 202, as VM 302 can directly visit the virtual switch functionality of peripheral card 200 by a corresponding VF. In some embodiments, VM 302 can install a VF driver in its guest operating system to cooperate with the VF. The guest operating system included in VM 302 can be, for example, Microsoft™ Windows™, Ubuntu™, Red Hat™ Enterprise Linux™ (RHEL), etc.

Controller 304, as an administrator over the virtual switch functionality of peripheral card 200, can be configured to initialize peripheral card 200. Compared with virtual switch 100 shown in FIG. 1, controller 304 is the only component of the virtual switch according to embodiments of the disclosure that still remains in host system 300.

To exchange data between the controller 304 and peripheral card 200, first message proxy 306 and second message proxy 310 are provided. First message proxy 306 can receive, process, and send messages from or to peripheral card 200. Similarly, second message proxy 310 of peripheral card 200 can receive, process, and send messages from or to controller 304.

Driver 308 can write data (e.g., configuration information generated by controller 304) into peripheral card 200 via peripheral interface 202. Once written, driver 308 enters a loop to spin for response from peripheral card 200. For example, the configuration information for processor unit 204 can be written into peripheral card 200 by controller 304 through driver 308.

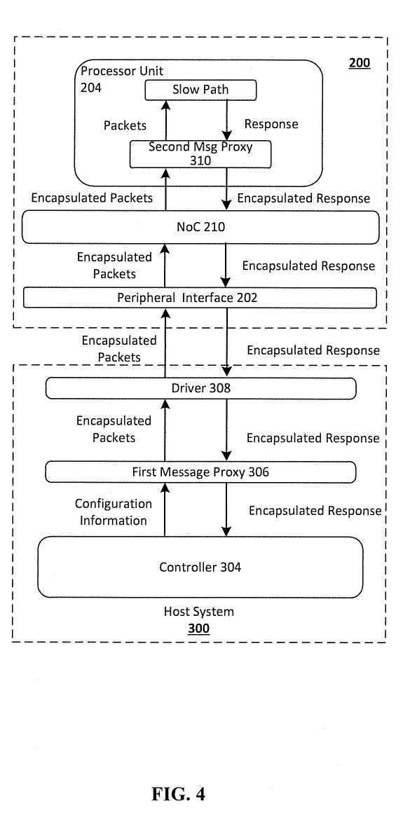

FIG. 4 illustrates an exemplary initialization procedure between processor unit 204 and controller 304, consistent with embodiments of the present disclosure.

Controller 304 can generate configuration information and send it to first message proxy 306 in the kernel space. First message proxy 306 then processes packets of the configuration information. In some embodiments, first message proxy 306 can encapsulate the packets of the configuration information with a control header. The control header can indicate the type of the configuration information.

The encapsulated packets can be further passed to driver 308, which further writes the encapsulated packets into peripheral interface 202 of peripheral card 200. In some embodiments, the encapsulated packets can be written into a base address register (BAR) space of peripheral interface 202.

The received packets can be further relayed to processor unit 204 via NoC 210 as a bridge. In some embodiments, peripheral interface 202 can notify (e.g., raising an interrupt) processor unit 204 about the received packets.

In response to the notification, second message proxy 310 of processor unit 204 can decapsulate the received packets to extract the configuration information, and send the configuration information to be executed by the slow path codes for processing. In some embodiments, the configuration information can be processed to generate a flow table including flow entries by processor unit 204.

After the configuration information has been processed, processor unit 204 can send a response to controller 304. The response can be sent to second message proxy 310 to be encapsulated, and received by controller 304 via peripheral interface 202. The encapsulated response can be written to a predefined response area in the BAR space of peripheral interface 202.

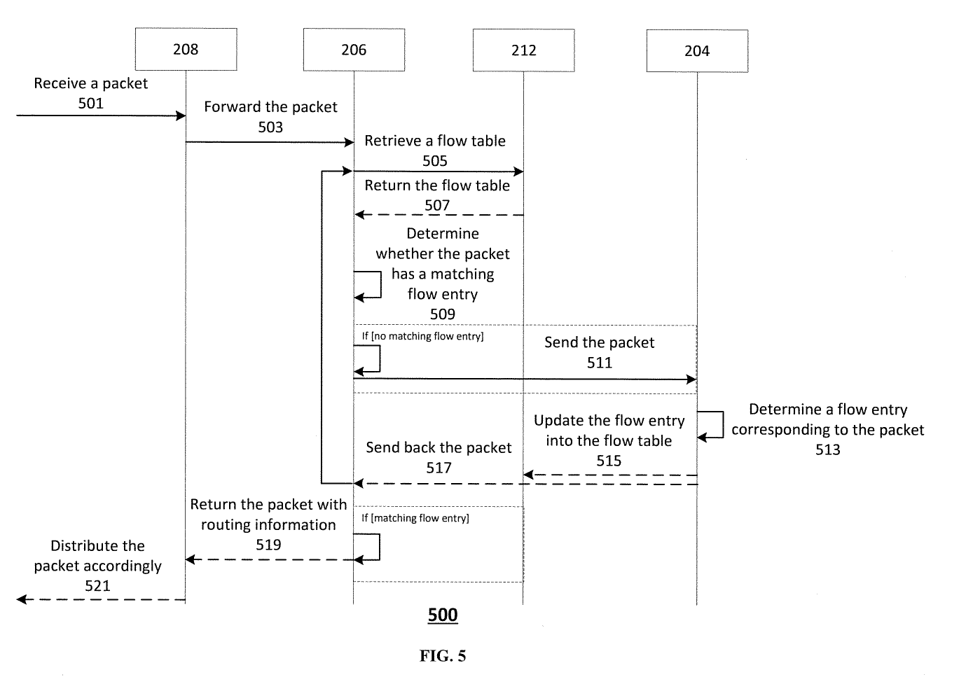

With the flow table generated based on the configuration information, peripheral card 200 can perform the virtual switch functionality without occupying too many resources of host system 300. FIG. 5 illustrates an exemplary data flow for peripheral card 200 to process packets, consistent with embodiments of the present disclosure.

As shown in FIG. 5, network interface 208 receives (501) a packet. As discussed above, the packet can be a packet from an external source. The packet can be forwarded (503) to packet processing engine 206. It is contemplated that if the packet is from the virtual machines of the host system, the packet can be directly sent to packet processing engine 206. Packet processing engine 206 can determine whether the packet has a matching flow entry.

For example, packet processing engine 206 can request to retrieve (505) a flow table containing flow entries from memory device 212. After the flow table is returned (507) to packet processing engine 206, packet processing engine 206 can process the packet to determine (509) whether the packet has a matching flow entry.

If no matching flow entry is found, packet processing engine 206 can send (511) the packet to processor unit 204 for further process. For example, processor unit 204 can analyze the header of the packet and determine (513) a flow entry corresponding to the packet accordingly. Processor unit 204 can then update (515) the determined flow entry into the flow table stored in memory device 212, and further send back (517) the packet to packet processing engine 206. As shown in FIG. 5, packet processing engine 206 can then re-perform the retrieving and determining a matching flow entry.

If a matching flow entry is found, packet processing engine 206 can return (519) the packet with routing information to network interface 208, so that network interface 208 can distribute (521) the packet accordingly based on the routing information. It is contemplated that, when the packet is a packet returned by processor unit 204, with the flow table being updated, packet processing engine 206 can find the matching flow entry. In this case, the packet is referred to as a first packet.

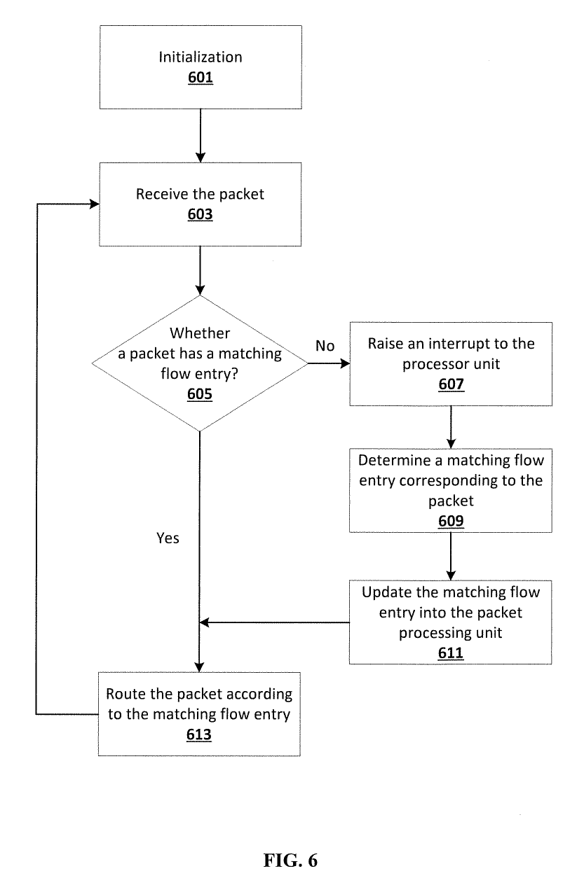

FIG. 6 is a flow chart of an exemplary method 600 for distributing packets, consistent with embodiments of the present disclosure. For example, method 600 can be implemented by a virtual switch of peripheral card 200, and can include steps 601-611. In some embodiments, the virtual switch can be implemented by processor unit 204 and packet processing engine 206, functioning as a slow path and a fast path respectively.

In step 601, the virtual switch can be initialized by host system 300 having a controller and a kernel. For example, the virtual switch can be initialized by configuration information generated by host system 300 to establish a flow table. For example, the initialization procedure can correspond to the initialization procedure discussed above in FIG. 4, and description of which will be omitted herein for clarity.

In step 603, packets can be received by the virtual switch. Packets to be handled by the virtual switch can be generated from host system 300 or an external source. For example, host system 300 can include a plurality of virtual machines (VMs) to generate the packets. The packets can be received by peripheral card 200. For example, peripheral card 200 can create a plurality of virtual functions (VF), and the packets can be received by the respective VFs and sent to the virtual switch.

In step 605, the virtual switch can determine whether a packet has a matching flow entry in the flow table. The flow table is established in peripheral card 200 to include a plurality of flow entries corresponding to respective packets. If a packet has a matching flow entry in the flow table, then the packet will be routed by packet processing engine 206 (i.e., the fast path) according to the matching flow entry. If, however, the packet has no matching flow entry in the flow table, then the packet will be delivered to processor unit 204 for further processing.

Therefore, in step 607, after determining that the packet has no existing flow entry, packet processing engine 206 can raise an interrupt to processor unit 204 to invoke the slow path of the virtual switch. In response to the interrupt, processor unit 204 can process the packet in the next step.

In step 609, the slow path of the virtual switch (e.g., processor 204) can receive the packet sent by packet processing engine 206 and process the packet by slow path codes to determine a flow entry corresponding to the packet.

In step 611, the slow path can update the flow entry into the flow table. In some embodiments, the determined flow entry can be written into packet processing engine 206 by issuing a write to an address space of packet processing engine 206 on NoC 210. In the meanwhile, the slow path can send the packet back to packet processing engine 206. This packet can be named as a first packet, as it is the first one corresponding to the determined flow entry. Any other packets corresponding to the determined flow entry can be named as subsequent packets.

Then, in step 613, packet processing engine 206 can route the packet according to the matching flow entry. It is contemplated, when it is determined that the packet has a matching flow entry in step 605, the packet can be directly routed by the fast path without being processed in the slow path.

Most packets can find matching entries in the flow table of packet processing engine 206. In such cases, packets will simply flow through packet processing engine 206 (i.e., the fast path) and take the corresponding actions. There is no need to involve the slow path in processor unit 204.

Therefore, as described above, the whole process for performing the virtual switch functionality does not involve host system 300 at all, except step 601 for initializing. The majority of packets can be seamlessly processed in packet processing engine 206. If the packets missed in packet processing engine 206, slow path codes running in processor unit 204 can be invoked to take care of them. In both cases, the resources of host system 300 are not involved, and thus can be assigned to the VMs of cloud service customers for further revenue. Because packet processing engine 206 is a hardware implementation of a networking switch, it offers much higher throughput and scalability compared to the software implementation. And processor unit 204 runs a full-blown operating system to ensure the flexibility of peripheral card 200.

Another aspect of the disclosure is directed to an integrated circuit. The integrated circuit can be implemented in a form of a system-on-chip (SoC). The SoC can include similar functional components as described above. For example, the SoC can include components similar to a peripheral interface 202, a processor unit 204, a packet processing engine 206, a network interface 208, a network-on-chip (NoC) 210, a memory device 212, or the like. Detailed description of these components will be omitted herein for clarity.

Yet another aspect of the disclosure is directed to a non-transitory computer-readable medium storing instructions which, when executed, cause one or more processors to perform at least some of the steps from the methods, as discussed above. The computer-readable medium can include volatile or non-volatile, magnetic, semiconductor, tape, optical, removable, non-removable, or other types of computer-readable medium or computer-readable storage devices. For example, the computer-readable medium can be the storage device or the memory module having the computer instructions stored thereon, as disclosed. The one or more processors, that execute the instructions, can include similar components 202-212 of peripheral card 200 described above. Detailed description of these components will be omitted herein for clarity.

It will be apparent to those skilled in the art that various modifications and variations can be made to the disclosed virtual switch device and method. Other embodiments will be apparent to those skilled in the art from consideration of the specification and practice of the disclosed system and related methods. Although the embodiments are described an separate device as an example, the described virtual switch device can be applied an integrated component of a host system.

It is intended that the specification and examples be considered as exemplary only, with a true scope being indicated by the following claims and their equivalents.

1. A peripheral card for distributing one or more packets, comprising:
a peripheral interface configured to communicate with a host system having a controller and to receive one or more packets;
a processor unit configured to process the one or more packets according to configuration information provided by the controller;
a packet processing engine configured to route the one or more packets according to a flow table established via the processor unit; and
a network interface configured to distribute the routed one or more packets.

2. The peripheral card of claim 1, wherein the one or more packets are generated by virtual machines contained by the host system.

3. The peripheral card of claim 1, wherein the configuration information initializes the processor unit to establish the flow table.

4. The peripheral card of claim 1, wherein the packet processing engine is configured to further determine whether a packet has a matching flow entry in the flow table.

5. The peripheral card of claim 4, wherein after the packet processing engine determines that the packet has no matching flow entry in the flow table, the packet processing engine is further configured to raise an interrupt to the processor unit.

6. The peripheral card of claim 5, wherein the processor unit is further configured to:
receive the packet sent by the packet processing engine;
process the packet by slow path codes to determine a flow entry corresponding to the packet; and
update the flow entry into the flow table.

7. The peripheral card of claim 1, wherein the configuration information comprises at least one of a Forwarding Information Database (FIB), an Address Resolution Protocol (ARP) table, and an Access Control List (ACL) rules.

8. A method for distributing one or more packets performed by a virtual switch provided on a peripheral card that communicates with a host system having a controller, the method comprising:
receiving one or more packets;
processing the one or more packets according to configuration information provided by the controller;
routing the one or more packets according to a flow table; and
distributing the routed packets.

9. The method of claim 8, further comprising initializing the virtual switch by the configuration information to establish the flow table.

10. The method of claim 8, wherein processing the one or more packets according to configuration information provided by the controller further comprises:
determining whether a received packet has a matching flow entry in the flow table.

11. The method of claim 10, further comprising raising an interrupt to the processor unit, after determining that the received packet has no existing flow entry in the flow table.

12. The method of claim 11, further comprising:
processing the packet by slow path codes to determine a flow entry corresponding to the packet; and
updating the flow entry into the flow table.

13. A communication system comprising a host system and a peripheral card, wherein the host system comprises a controller;
the peripheral card comprises:
a peripheral interface configured to communicate with the host system and to receive one or more packets;
a processor unit configured to process the packets according to configuration information provided by the controller;
a packet processing engine configured to route the packets according to a flow table established via the processor unit; and
a network interface configured to distribute the routed packet.

14. A non-transitory computer readable medium that stores a set of instructions that is executable by at least one processor of a device to cause the device to perform a method for distributing packets, the method comprising:
receiving one or more packets from a host system having a controller;
processing the packets according to configuration information provided by the controller;
routing the packets according to a flow table; and
distributing the routed packets.

15. The non-transitory computer readable medium of claim 14, wherein the set of instructions is executable by the at least one processor of the device to cause the device to further perform:
initializing the virtual switch by the configuration information to establish the flow table.

16. The non-transitory computer readable medium of claim 14, wherein the set of instructions is executable by the at least one processor of the device to cause the device to further perform:
determining whether a packet has a matching flow entry in the flow table.

17. The non-transitory computer readable medium of claim 16, wherein the set of instructions is executable by the at least one processor of the device to cause the device to further perform:
raising an interrupt to the processor unit, after determining that the packet has no existing flow entry in the flow table.

18. The non-transitory computer readable medium of claim 17, wherein the set of instructions is executable by the at least one processor of the device to cause the device to further perform:
processing the packet by slow path codes to determine a flow entry corresponding to the packet; and
updating the flow entry into the flow table.
